(19) United States
(12) Patent Application Publication
(10) Pub. No.: US 2006/0222423 A1
(43) Pub. Date: Oct. 5, 2006

(54) Heat-pipe fuser roll with internal coating

(75) Inventors: Jeremy C. Dejong, Webster, NY (US); Donald M. Bott, Rochester, NY (US); Gerald A. Domoto, Briarcliff Manor, NY (US); David H. Pan, Rochester, NY (US); Nicholas P. Kladias, Flushing, NY (US); Osman T. Polatkan, North Haledon, NJ (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/094,423

(22) Filed: Mar. 31, 2005

(51) Int. Cl. G03G 15/20

(52) U.S. Cl. 399/333

(57) ABSTRACT

An energy transfer device and system includes a heat pipe and an interior coating to at least a portion of an interior surface of the heat pipe, the interior coating comprises at least one of the properties selected from chemically inert, liquid phobic, stable at high temperature, of low porosity and of low surface energy. Moreover, a manufacturing method of an energy transfer device that includes providing a heat pipe and providing an interior coating to an interior surface of at least a portion of the heat pipe, the interior coating comprising at least one of the properties selected from chemically inert, liquid phobic, stable at high temperature, of low porosity and of low surface energy.

### BACKGROUND

Maintaining temperature uniformity of a fuser roll has long been a problem when varying media sizes in printing systems. In order to solve these uniformity issues, using a heat pipe as a fuser roll has been previously disclosed. Problems generally arise though in the complexity of the design of such heat pipe fuser rolls because the heat pipe generally acts as a closed system, and applying heat internally becomes difficult. Previous disclosures recommend applying heat at one end of the fuser roll, which simplifies the geometry of the subsystems. By applying all the heat at one end of the system, the incident heat flux at that end is increased, and because there is a need to minimize the amount of water in the heat pipe for instant-on applications, there is a potential for dry-out of the heat pipe evaporator. Preventing evaporator dry-out by pumping fluids using more complex interior geometries has also been proposed. The resulting interior structures are more easily constructed in tubes made out of aluminum. However, aluminum is an incompatible wall material for a heat pipe using water as a working fluid because aluminum corrodes easily in the presence of water. For this reason, the aluminum may be coated with a chemically inert layer in water-based heat pipes. For instance, the following references describe heat pipes with specifically configured internal structures: U.S. application Ser. No. ______ (Attorney Docket No. 123346; Xerox ID # 20040097-US-NP); U.S. Pat. No. 4,773,476; “Helical Guide-Type Rotating Heat Pipe”, Shimizu, A. and Yamazaki, S., 6^{th} International Heat Pipe Conference, 1987; “Heat Transfer and Internal Flow Characteristics of a Coil-Inserted Rotating Heat Pipe”, Lee, J. and Kim, C., International Journal of Heat and Mass Transfer, 2001.

Differences in the preferred materials for induction heating, heat pipes, and fuser rolls generally make their combination difficult. Induction heating is preferably used with a magnetic, electrically resistive metal such as, for example, steel. A fuser roll manufacturer generally prefers a low-cost, light-weight, easy-to-process metal such as, for example, aluminum. On the other hand, water as the working fluid is preferred as a heat pipe operating in a temperature range of a typical fuser, which can be 150-250° C. At all temperatures, water vapor is reactive with the preferred core materials.

### SUMMARY

Under normal operating conditions, aluminum and water are incompatible as heat pipe materials because thermal cycling conditions may cause aluminum to undergo stress cracking. Thermal stress cracking is generally due to the difference between the thermal expansion coefficients of aluminum and its oxide, and does not occur at room temperature. Once a crack has formed, water is then exposed to bare aluminum, which then corrodes. Accordingly, water film condensation on the coating limits the choices of coating material. At elevated temperatures, the water and iron in the steel may react to corrode the steel and form a non-condensable gas in the heat pipe, thus limiting its effectiveness. Porosity, coating imperfections, and a thermal expansion mismatch between the coating the underlying metal may cause stress cracking and thus limits the choices of coating material.

In light of these problems and shortcomings, various exemplary embodiments of devices and methods may provide an energy transfer device that includes a heat pipe and an interior coating to the heat pipe, wherein the heat pipe is to provide uniform heating and the interior coating is at least one of chemically inert, liquid phobic, stable at a high temperature, low porosity and low surface energy.

Moreover, various exemplary implementations may provide a manufacturing method for an energy transfer device that includes providing a heat pipe and providing an interior coating to the heat pipe, wherein the heat pipe is to provide uniform heating and the interior coating is at least one of chemically inert, liquid phobic, stable at high temperature, low porosity, and low surface energy.

### BRIEF DESCRIPTION OF THE DRAWINGS

Various exemplary implementations of systems are described in detail with reference to the following figures, wherein:

FIG. 1 is an illustration of an exemplary heat pipe according to various implementations;

FIG. 2 is a curve describing warm up times for aluminum heat pipes with respect to wall thickness and water fill level according to various exemplary implementations;

FIG. 3 is an illustration of an exemplary internal configuration of a heat pipe fuser according to various exemplary implementations; and

FIG. 4 is a flowchart illustrating an exemplary manufacturing method of an energy transfer device, according to various exemplary implementations.

### DETAILED DESCRIPTION OF EMBODIMENTS

These and other features and advantages are described in, or are apparent from, the following detailed description of various exemplary embodiments.

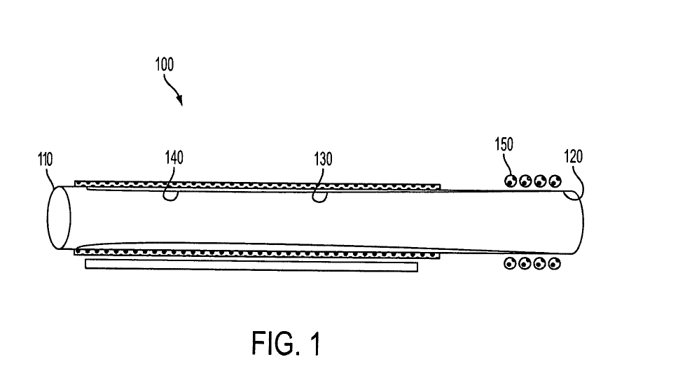

FIG. 1 is an illustration of an exemplary heat pipe 100 according to various implementations. The heat pipe 100 may be fabricated from aluminum in the form of a fuser roll 110 with an internal structure that facilitates the return flow of liquid to an evaporator section 120. According to various implementations, the components of the heat pipe 100 may be coated on interior facing surfaces 130 of the fuser roll 110 with a protective layer used as an interior coating 140 such as, for example, nickel. The interior coating 140 may be of significant thickness, for example between 5 μm and 25 μm, to minimize its porosity to about less than one spot per square centimeter, and in some cases to less than about one spot per square inch. Porosity is measured on the basis of measurement techniques described in ASTM B 733-97. According to various implementations, after coating, the components of the heat pipe 100 may then be joined together to define an interior volume. The volume may then be evacuated, back-filled with the working fluid, preferably water, and hermetically sealed. According to various exemplary implementations, coating the interior surfaces of the aluminum fuser roll 110 with nickel may provide a barrier to the corrosion of the fuser roll 110, thus maintaining safe operation of the heat pipe 100.

Nickel coating of steel may be used because of the magnetic properties of nickel, its close-packed structure when alloyed with phosphorus, and its similar coefficient of thermal expansion as compared to steel. The coefficient of thermal expansion of electroless nickel generally ranges from 12-14.5 ppm/° C. for a few % up to 15% phosphorous (steel˜12 ppm/° C.). Additionally, a nickel coating may be alloyed with boron to provide similar characteristics as the phosphorus alloy with improved ductility. Electroless nickel-phosphorus and nickel-boron coating of steel is a well documented process and provides superior corrosion resistance to stainless steel at a comparable or cheaper cost. An extended section 150 of the heat pipe may be placed in an alternating field generated by the induction coil and the fuser is operational.

In addition to the protective characteristics of nickel coating, nickel coating may also act as a magnetic susceptor in, for example, an induction heating application. Coating the non-magnetic fuser roll 110 made of, for example, aluminum, with a magnetic material such as, for example, nickel, may provide a heat source on the interior of the fuser roll 110, thus increasing the induction heating efficiency of the non-magnetic fuser roll 110.

Generally, nickel coating an aluminum fuser roll 110 enables low end instant-on applications. Without a protective coating, the aluminum shell may be unusable with water, which happens to generally be the most suitable working fluid. Also, without special internal structures that are most easily machined into aluminum, the amount of water necessary to avoid evaporator dry-out may limit the warm-up times available for instant-on applications.

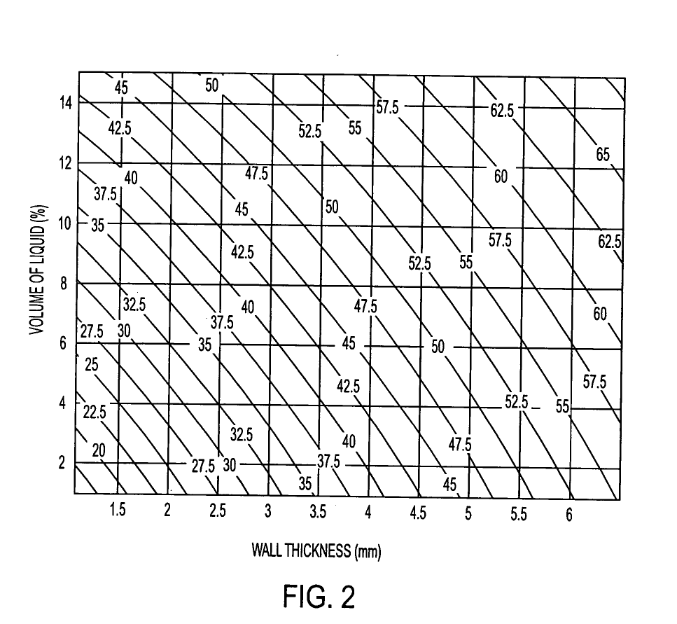

FIG. 2 is a curve describing warm-up times for aluminum heat pipes with respect to wall thickness and water fill level according to various exemplary implementations. The time required for the fuser to warm-up may be an important machine characteristic in the office equipment market. Customers generally prefer as short a wait as possible for their output from a given machine. In general, minimizing the waiting time may be accomplished by keeping the fuser ‘hot’ in standby mode for extended periods of time, which may waste energy. Providing a machine with a fuser that warmed-up rapidly may reduce such waste of energy while still satisfying the customer with a short wait. Table 1 below indicates compatibility data for working fluid, wick and container.

TABLE 1

| Material | Water | Acetone | Ammonia | Methanol |
|---|---|---|---|---|
| Copper | RU | RU | NU | RU |
| Aluminum | GNC | RL | RU | NR |
| Stainless Steel | GNT | PC | RU | GNT |
| Nickel | PC | PC | RU | RL |
| Refrasil | RU | RU | RU | RU |
| Material | Dow-A | Dow-E | Freon 11 | Freon 113 |
| Copper | RU | RU | RU | RU |
| Aluminum | UK | NR | RU | RU |
| Stainless Steel | RU | RU | RU | RU |
| Nickel | RU | RL | UK | UK |
| Refrasil | RU | | UK | UK |

RU, recommended by past successful usage;
RL, recommended by literature;
PC, probably compatible;
NR, not recommended;
NU, not used;
UK, unknown;
GNC, generation of gas at all temperatures;
CNT, generation of gas at elevated temperatures when oxide is present.

According to various exemplary implementations, the heat pipe 100 may be fabricated in the form of, for example, the fuser roll 110 with the extended section 150 that may be heated. According to various exemplary implementations, the components of the heat pipe 100 may be coated on the interior facing surface 130 with the protective layer 140, preferably liquid-phobic fluoropolymer such as, for example, poly(tetrafluoroethylene). Poly(tetrafluoroethylene) coating is hydrophobic and may promote a higher transport rate of dropwise condensation, as well as increase the gravity driven flowrate of condensed liquid droplets back from the condenser end to the evaporator end of the heat pipe 100, due to the destruction of the boundary layer. According to various exemplary embodiments, coating the inner surface 120 of the evaporation section 150 of the heat pipe 100 with a hydrophobic surface may also increase the critical heat flux for the onset of film boiling, which may allow for a shorter evaporator length. Additionally, the fluoropolymer coating 130 may be less susceptible to stress cracking due to thermal cycling, than other coating materials, which need to match the coefficient of thermal expansion between the coating and the substrate.

The internal surface 130 of the heat pipe 100 may be coated by powder coating of, for example, poly(tetrafluoroethylene) or poly(tetrafluoroethylene-co-perlfuoroalkyl ether) particles, followed by sintering of particles to form a continuous protective film at about 350-400 ° C. The internal surface 130 of the heat pipe 100 may be coated by simultaneous spin casting and drying of a liquid dispersion of Poly(tetrafluoroethylene) or poly(tetrafluoroethylene-co-perlfuoroalkyl ether) particles, followed by sintering of particles to form a continuous protective film at about 350-400 ° C. The internal surface 130 of the heat pipe 100 may be coated by simultaneous spin casting and drying of a solution of soluble Teflon AF 2400, followed by complete solvent removal to form a continuous protective film at about 250-300 ° C. In addition, the liquid-phobic coating may be filled with thermally conductive particles such as SiC or alumina. Depending on the filler particle loading, thermal conductivity of the resulting coating may be improved by as much as approximately 50 to 200%.

The components of the heat pipe 100 may be coated on their interior facing surface 130 with protective layer of electroless nickel (EN) (Ni-Phosphorous or Ni-Boron alloy) poly(tetrafluoroethylene) nanocomposite. The EN containing less than about 8% phosphorous is magnetic, and thus may be used as a susceptor for induction heating. The poly(tetrafluoroethylene) is hydrophobic and may promote the higher transport rate of dropwise condensation as well as increasing the gravity driven flowrate of condensed liquid back from the condenser end to the evaporator end of the heat pipe. The electroless nickel solution containing micron-size or nanometer-size poly(tetrafluoroethylene) particles may be used to deposit the EN poly(tetrafluoroethylene) composite. The poly(tetrafluoroethylene) particles may be incorporated in the EN coating as the EN coating is formed. The resulting EN poly(tetrafluoroethylene) nanocomposite may contain up to approximately 25% by weight of poly(tetrafluoroethylene). The nanocomposite coating has inherently fewer imperfections. A post-coating heat treatment may then be performed to better seal the imperfections such as pores or cracks.

The electroless nickel solution containing no poly(tetrafluoroethylene) particles may be used to deposit the EN coating in the interior surfaces of the heat pipe. The resulting EN surfaces may then be exposed to a dispersion containing poly(tetrafluoroethylene) micro or nanoparticles and the pores or cracks may be sealed by poly(tetrafluoroethylene) particles. The post-sealing heat treatment may be needed to sinter the poly(tetrafluoroethylene) particles in order to provide a better seal against water vapor. The thermal and rheological properties of the incorporated polymer components may be designed to self-heal or close up the induced cracks due to thermal cycling. Some polymer composites may require a somewhat higher temperature than the nominal fuser operating temperature in order to self-heal. If the metal coating is magnetic, the self-healing due to polymer sintering or melt flow may be achieved through a very short period of overheating in the coating with an induction coil. Table 2 indicates relative induction heating efficiencies for potential heat pipe fuser rolls. The magnetic properties of steel allow for more efficient heating than the non-magnetic stainless steel.

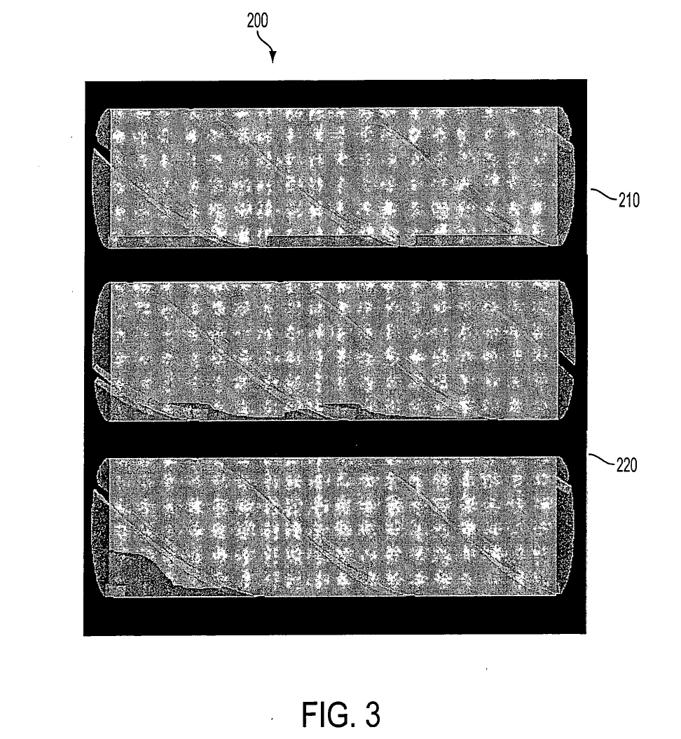

FIG. 3 is an illustration of an exemplary internal configuration of a heat pipe fuser 200. In FIG. 3, the internal surface 200 of the heat pipe is illustrated, comprising structural features such as, for example, spiral ribs 210 superimposed over ridges 220. The spiral ribs are rotating along the same direction. The spiral ribs may act as a mechanism that facilitates liquid return flow to the evaporator section of the heat pipe. The augmented return flow may be necessary to prevent evaporator dry-out for heat pipe filled with a minimal amount of working fluid.

Generally, nickel coating a steel heat pipe enables a cost effective mid-volume applications where steady state power consumption is important. According to various exemplary implementations, another option for a core material in this class includes more expensive stainless steel with secondary surface treatments. Without a protective coating on the steel shell, it may be unusable with water because of non-condensable gas formation. Other working fluids are incapable of transmitting enough heat through the pipe due to lower values for their heats of vaporizations as compared to water. This may limit the thermal distribution effectiveness of the heat pipe fuser roll.

TABLE 2
Relative induction heating efficiencies for potential heat fuser roll cores

| Material | Induction Heating Efficiency |
|---|---|
| Steel | 85% |
| Stainless Steel | 67% |
| Aluminum | 11% |
| Copper | 7% |
| Brass | 18% |

Table 3 indicates useful temperature ranges for potential heat pipe working fluids.

TABLE 3
Useful temperature range for potential heat pipe working fluids

| | | BOILING PT. | |
|---|---|---|---|
| | | AT ATM. | USEFUL |
| | MELTING PT. | PRESSURE | RANGE |
| MEDIUM | (° C.) | (° C.) | (° C.) |
| Helium | −271 | −261 | −271 to −269 |
| Nitrogen | −210 | −196 | −203 to −160 |
| Ammonia | −78 | −33 | −60 to 100 |
| Acetone | −95 | 57 | 0 to 120 |
| Methanol | −98 | 64 | 10 to 130 |
| Flutec PP2 | −50 | 76 | 10 to 160 |
| Ethanol | −112 | 78 | 0 to 130 |
| Water | 0 | 100 | 30 to 200 |
| Toluene | −95 | 110 | 50 to 200 |
| Mercury | −39 | 361 | 250 to 650 |
| Sodium | 98 | 892 | 600 to 1200 |
| Lithium | 179 | 1340 | 1000 to 1800 |
| Silver | 960 | 2212 | 1800 to 2300 |

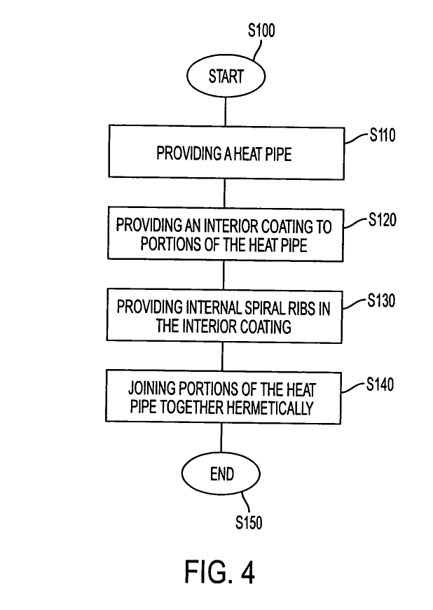

FIG. 4 is a flowchart illustrating an exemplary manufacturing method of an energy transfer device. In FIG. 4, the method starts in step S100, and continues to step S110. During step S110, a heat pipe may be provided. The control continues to step S120, during which an interior coating may be provided to various portions of the heat pipe. The interior coating may be chemically inert so as not to react with, for instance, water, and deteriorate as a result. The interior coating may be liquid phobic so as to repel water and prevent it from penetrating the coating and the underlying metallic structure, and may be stable at a high temperature. The interior coating may have a low porosity and a low surface energy, for example, a surface energy between 0 and 50 dynes/cm. Next, control continues to step S130.

During step S130, the interior coating provided in step S120 may be configured such as to exhibit spiral ribs. Configuring the interior coating to exhibit spiral ribs may be performed prior to providing the interior coating to the heat pipe, and it may be performed after the interior coating is provided to the heat pipe. Next, control continues to step S140.

During step S140, the various portions of the heat pipe that were coated as in, for example, during steps S120 and S130, may be joined back together to define an interior volume. The volume may then be evacuated, back-filled with the working fluid such as, for example, water, and hermetically sealed. Next, control continues to step S150, where the method ends.

It will be appreciated that variants of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. An energy transfer device, comprising:
a heat pipe; and
an interior coating to at least a portion of an interior surface of the heat pipe; wherein
the interior coating comprises the properties of chemically inert, liquid phobic, stable at high temperature, of low porosity and of low surface energy.

2. The energy transfer device of claim 1, wherein the energy transfer device comprises at least one of a fuser roll, a photoreceptor, and a paper transport device.

3. The energy transfer device of claim 2, wherein the heat pipe comprises at least one of a steel heat pipe and an aluminum heat pipe.

4. The energy transfer device of claim 2, further comprising an inductive heater to heat the heat pipe.

5. The energy transfer device of claim 4, wherein the inductive heater comprises induction coils located at least at one of one end of the heat pipe, along a length of the heat pipe, both ends of the heat pipe and inside the heat pipe.

6. The energy transfer device of claim 3, wherein an interior surface of the aluminum heat pipe comprises interior surface patterns.

7. The energy transfer device of claim 6, wherein the interior surface geometries comprise spiral ribs.

8. The energy transfer device of claim 1, wherein the interior coating is chemically inert to at least one of water and steam.

9. (canceled)

10. The energy transfer device of claim 1, wherein the interior coating has a thickness in a range 5 mm to 25 mm, and porosity is less than one spot per square inch.

11. The energy transfer device of claim 1, wherein the interior coating comprises at least one of a nickel-phosphorus alloy and a nickel-boron alloy.

12. (canceled)

13. A manufacturing method of an energy transfer device, comprising:
providing a heat pipe; and
providing an interior coating to an interior surface of at least a portion of the heat pipe, the interior coating comprising the properties of chemically inert, liquid phobic, stable at high temperature, of low porosity and of low surface energy.

14. The method of claim 13, further comprising providing a surface pattern to the interior surface of at least a portion of the heat pipe.

15. The manufacturing method of claim 13, wherein providing an interior coating comprises:
coating an inside surface of the heat pipe with a powder comprising particles; and
sintering the particles to form a continuous protective film.

16. (canceled)

17. The manufacturing method of claim 13, wherein sintering the particles is performed in a temperature range of about 300 ° C. to about 500 ° C.

18. The manufacturing method of claim 13, wherein providing an interior coating comprises:
simultaneous spin casting a solution comprising particles and a solvent;
drying the solution; and
removing the solvent to form a continuous protective film.

19. The manufacturing method of claim 18, wherein removing the solvent is performed in a temperature range of about 250 ° C. to about 300 ° C.

20. The manufacturing method of claim 13, wherein providing an interior coating comprises:
coating an interior surface of the heat pipe with a coating material comprising one of electroless nickel, a nickel-phosphorous alloy, a nickel-boron alloy.

21. The method of claim 13, further comprising providing an inductive heater to heat the heat pipe.

22. A xerographic device comprising the energy transfer device of claim 1.

23. A xerographic system comprising:
a heat pipe; and
a controller that controls an operation of the heat pipe in the xerographic system; wherein
an interior coating to at least a portion of an interior surface of the heat pipe is provided; and
the interior coating comprises the properties of chemically inert, liquid phobic, stable at high temperature, of low porosity and of low surface energy.
